(19) United States
(12) Patent Application Publication
(10) Pub. No.: US 2012/0209534 A1
(43) Pub. Date: Aug. 16, 2012

(54) METHOD AND SYSTEM FOR ANALYZING LIQUID

(75) Inventors: Dan Shahar, Tel-Aviv (IL); Ziv Reich, Rehovot (IL); Ruti Kapon, Rehovot (IL)

(73) Assignee: YEDA RESEARCH AND DEVELOPMENT CO., LTD. AT THE WEIZMANN INSTITUTE OF SCIENCE, Rehovot (IL)

(21) Appl. No.: 13/502,819

(22) PCT Filed: Oct. 19, 2010
(86) PCT No.: PCT/IL10/00853

§ 371 Date: Apr. 19, 2012

Related U.S. Application Data
(60) Provisional application No. 61/252,792, filed on Oct. 19, 2009.

(51) Int. Cl. G06F 15/00; G01F 1/00; G01N 27/00

(52) U.S. Cl. 702/19; 702/50; 702/46; 702/25

(57) ABSTRACT

A method of analyzing liquid is disclosed. The method comprises: obtaining data pertaining to a dripping pattern characterizing formation of liquid drops as a function of the time, and comparing the dripping pattern to a reference dripping pattern.

### RELATED APPLICATION

This application claims the benefit of priority from U.S. Patent Application No. 61/252,792 filed Oct. 19, 2009, the contents of which are hereby incorporated by reference as if fully set forth herein.

### FIELD AND BACKGROUND OF THE INVENTION

The present invention, in some embodiments thereof, relates to liquid analysis and, more particularly, but not exclusively, to a method and system for analyzing liquid by monitoring formation of liquid drops.

In multi-component liquid compositions, it is oftentimes desired to analyze the liquids so as to determine the concentration of various components therein. Numerous techniques have been devised over the years for the analysis of liquids.

Many techniques (see, e.g., U.S. Pat. No. 6,413,473) employ chemical reactions for the analysis. These techniques can be generally divided into “dry chemistry” techniques and “wet chemistry” techniques. In wet chemistry techniques, a liquid testing agent or a dissolvable testing agent is added to a liquid sample. The testing agent reacts with the analyte of interest, leading to formation of a detectable signal, such as a visible marker (e.g., color or change in color). The detectable signal is then compared to some reference standard to determine the presence or level of the analyte. In dry chemistry techniques, an absorbent pad or a test strip is impregnated, coated or printed with a test system. The absorbent pad or a test strip is contacted with the liquid sample, removed from it, and a signal is “read” on the absorbent pad or test strip. As with wet chemistry techniques, the signal that is generated is compared to a coded reference to link the signal generated to a specific amount and/or concentration of an analyte under consideration.

Also known are automatic techniques for analyzing liquids. In one such technique (see, e.g., U.S. Pat. No. 4,958,295), a liquid sample of small volume is injected into a carrier stream so that the injected sample forms a zone. The zone disperses in the carrier and is subject to examination in a detector. Typically, the sample reacts with the carrier to form a reaction product which is sensed in a detector and the sensed data is recorded. In another such technique (see, e.g., U.S. Pat. No. 4,236,075) optical radiation (typically in the infrared range) is passed through the liquid and the concentration of the analyte in the liquid is determined based on the amount of absorbed radiation as a function of the wavelength.

Some techniques employ a sensor or probe that comes in contact with the liquid to be measured. One such technique (see, e.g., U.S. Pat. No. 5,673,341) makes use of an optical fiber as a sensor, and an end of the core (waveguide) of the optical fiber is contacted with liquid of an object of measurement such that optical information inputted thereto from the object liquid is transmitted to a measuring instrument using the optical fiber as a conductor.

Some techniques (see, e.g., U.S. Pat. No. 4,403,147) employ a mass spectrometer. A highly directional jet of very fine liquid droplets is evaporated and injection into the mass spectrometer. The mass spectrometer analyzes the liquid by liquid chromatography technique.

Some techniques (see, e.g., U.S. Pat. No. 6,028,433) employ an impedance sensor, e.g., a capacitive grid which serves as a component capacitor within an oscillator circuit. The liquid is placed in the sensor and affects the capacitance (and therefore the impedance) of the capacitive grid, which in turn affects an output oscillation frequency of the oscillator circuit. The output oscillation frequency is evaluated over a plurality of frequencies. Based on the data collected over the frequency range, conditions of the liquid are determined.

Some techniques (see, e.g., U.S. Pat. No. 4,626,413) employ ultraviolet light to induce a reaction which produces a gaseous product. The gaseous product is then measured by various techniques.

### SUMMARY OF THE INVENTION

According to an aspect of some embodiments of the present invention there is provided a method of analyzing liquid. The method comprises: obtaining data pertaining to a dripping pattern characterizing formation of liquid drops as a function of the time; comparing the dripping pattern to a reference dripping pattern; and issuing a report regarding the comparison thereby analyzing the liquid.

According to some embodiments of the invention the method further comprises accessing a database of reference dripping patterns, and searching the database for the reference dripping pattern.

According to some embodiments of the invention the method further comprises forming drops of the liquid, monitoring the formation of the drops, and generating the data pertaining to the dripping pattern responsively to the monitoring.

According to some embodiments of the invention the method further comprises varying a flow rate of the liquid, wherein the monitoring and the generation of the data is repeated for at least two different flow rates.

According to some embodiments of the present invention the data comprise electrical capacitance data describing electrical capacitance measured at a tip of a dripping device while the liquid drops are formed at the tip.

According to some embodiments of the present invention the data comprise electrical conductance data describing electrical conductance measured at a tip of a dripping device while the liquid drops are formed at the tip.

According to some embodiments of the present invention the data comprise electrical impedance data describing electrical impedance measured at a tip of a dripping device while the liquid drops are formed at the tip.

According to some embodiments of the present invention the data comprise optical data characterizing the formation of liquid drops.

According to some embodiments of the present invention the data comprise imagery data captured while the liquid drops are formed.

According to some embodiments of the present invention the data comprise at least one of: characteristic dripping period, characteristic shape of the liquid drops, time intervals between drops, characteristic periodicity level, and a flow rate corresponding to a transition from one dripping dynamic to another dripping dynamic.

According to some embodiments of the present invention the data correspond to at least one of: a time return map characterizing the formation of liquid drops, and a phase space reconstruction diagram characterizing the formation of liquid drops.

According to some embodiments of the present invention the data comprises at least one of an embedding dimension and a time delay interval characterizing a phase-space reconstruction of the formation of liquid drops.

According to an aspect of some embodiments of the present invention there is provided a computer-readable medium having stored thereon a computer program comprising code means for instructing a data processer to carry out at least some of the operations delineated above and/or further detailed hereinunder.

According to an aspect of some embodiments of the present invention there is provided a system for analyzing liquid. The system comprises: a dripping device for forming drops of the liquid; a monitoring device for monitoring the formation of the drops and generating data pertaining to dripping pattern characterizing formation of liquid drops as a function of the time; and a data processor configured for comparing the dripping pattern to a reference dripping pattern.

According to some embodiments of the invention the data processor is configured for accessing a database of reference dripping patterns, and searching the database for the reference dripping pattern.

According to some embodiments of the invention the monitoring device comprises an electrical capacitance measuring device configured for measuring electrical capacitance measured at a tip of the dripping device while the liquid drops are formed at the tip.

According to some embodiments of the invention the monitoring device comprises an electrical conductance measuring device configured for measuring electrical conductance at a tip of the dripping device while the liquid drops are formed at the tip.

According to some embodiments of the invention the monitoring device an electrical impedance measuring device configured for measuring electrical impedance measured at a tip of the dripping device while the liquid drops are formed at the tip.

According to some embodiments of the invention the monitoring device comprises an optical device configured for measuring temporal and/or geometrical features characterizing the formation of the liquid drops.

According to some embodiments of the invention the monitoring device comprises an imaging device configured for imaging the liquid drops while the drops are formed at a tip of the dripping device.

According to some embodiments of the invention the data comprise at least one of: characteristic dripping period, characteristic shape of the liquid drops, time intervals between drops, characteristic periodicity level, and a flow rate corresponding to a transition from one dripping dynamic to another dripping dynamic.

According to some embodiments of the invention the data correspond to at least one of: a time return map characterizing the formation of liquid drops, and a phase space reconstruction diagram characterizing the formation of liquid drops.

According to some embodiments of the invention the data comprises at least one of an embedding dimension and a time delay interval characterizing a phase-space reconstruction of the formation of liquid drops.

According to an aspect of some embodiments of the present invention there is provided a method of constructing a database. The method comprises: providing a plurality liquids of different types; and for each liquid type, forming drops of the liquid, monitoring the formation of the drops to assess a dripping pattern characterizing the formation as a function of the time, and recording the dripping pattern as an identifying feature of the liquid type; thereby constructing a database of dripping patterns.

According to some embodiments of the invention the method further comprises, for each liquid type, determining a concentration of at least one component in the liquid and recording the concentration as corresponding to a respective dripping pattern.

According to some embodiments of the invention the method wherein the concentration is determined by at least one analysis technique selected from the group consisting of chemical analysis, spectral analysis, biological analysis and any combination thereof.

According to some embodiments of the invention the monitoring comprises measuring electrical capacitance at a tip of a dripping device while the liquid drops are formed at the tip.

According to some embodiments of the invention the monitoring comprises measuring electrical conductance at a tip of a dripping device while the liquid drops are formed at the tip.

According to some embodiments of the invention the monitoring comprises measuring electrical impedance measured at a tip of a dripping device while the liquid drops are formed at the tip.

According to some embodiments of the invention the monitoring comprises using an optical device for measuring temporal and/or geometrical features characterizing the formation of the liquid drops.

According to some embodiments of the invention the monitoring comprises imaging the liquid drops while the liquid drops are formed.

According to some embodiments of the invention the recording of dripping pattern comprises recording data which comprise at least one of: characteristic dripping period, characteristic shape of the liquid drops, time intervals between drops, characteristic periodicity level, and a flow rate corresponding to a transition from one dripping dynamic to another dripping dynamic.

According to some embodiments of the invention the recording of dripping pattern comprises recording data which correspond to at least one of: a time return map characterizing the formation of liquid drops, and a phase space reconstruction diagram characterizing the formation of liquid drops.

According to some embodiments of the invention the data comprises at least one of an embedding dimension and a time delay interval characterizing a phase-space reconstruction of the formation of liquid drops.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a series of images describing the formation of a single liquid drop at a tip of a dripping device under gravitational force;

FIG. 2 is a flowchart diagram of a method 20 suitable for analyzing a liquid, according to various exemplary embodiments of the present invention;

FIG. 3 is a flowchart diagram describing a method suitable for constructing a database, according to various exemplary embodiments of the present invention;

FIG. 4 is a schematic illustration of a system for analyzing liquid, according to various exemplary embodiments of the present invention;

FIG. 5 is a schematic illustration of an exemplified system used in experiments performed according to some embodiments of the present invention;

FIG. 6 shows a plot of capacitance as a function of the time, and microscope images of a drop while being formed according to some embodiments of the present invention;

FIGS. 7A-F are dripping patterns for several types of liquids as measured by a capacitance measuring device according to some embodiments of the present invention;

FIGS. 8A-C show dripping patterns for several average drip rates, as measured by a capacitance measuring device according to some embodiments of the present invention;

FIGS. 8D-F are return maps showing time intervals between drops, as measured during experiments performed according to some embodiments of the present invention;

FIGS. 9A-C are three dimensional graphs showing phase space reconstructions of dripping dynamic, as obtained according to some embodiments of the present invention.

FIG. 10 shows concentration of ethanol solutions in percentage (logarithmic scale) as a function of the dripping frequency (Hz), for a flow rate of 40 ml/hr (upper curve and symbols) and 50 ml/hr (lower curve and symbols).

### DESCRIPTION OF SPECIFIC EMBODIMENTS OF THE INVENTION

The present invention, in some embodiments thereof, relates to liquid analysis and, more particularly, but not exclusively, to a method and system for analyzing liquid by monitoring formation of liquid drops.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Some embodiments of the present invention are described below with reference to flowchart diagrams describing operations which can be performed by the method and system of the present embodiments. It is to be understood that, unless otherwise defined, operations described hereinbelow can be executed either contemporaneously or sequentially in many combinations or orders of execution. Specifically, the ordering of the flowchart diagrams is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed.

The present embodiments are useful for analyzing any type of liquid, particularly liquids which can form drops, e.g., when pulled away from a tip of a dripping device by gravitational force. The liquid to be analyzed by the method and system of the present embodiments is preferably, but not necessarily, a multicomponent liquid.

A “multicomponent liquid,” as used herein refers to a mixture of two or more liquid components, or a composition having more than one component in liquid form.

The liquid components in the multicomponent liquid can be aqueous, non-aqueous, oily or non-oily.

The liquid to be analyzed can also be a liquid composition which comprises a liquid carrier (either single component or multicomponent liquid carrier) and non-liquid objects of microscopic or nanometric size. Such objects can be organic, nonorganic or biological substances, including microorganisms.

The liquid to be analyzed by the method and system of the present embodiments can also be a pure liquid or a single component liquid, namely a liquid which is not a mixture of several liquid components. This embodiment is useful, for example for identifying the liquid.

Some embodiments of the present invention relate to the analysis of a liquid, e.g., for the purpose of determining the relative amounts of the liquid components or objects present in the liquid, determining whether the liquid is a single component liquid, and/or determining whether not the liquid is contaminated or deteriorated. In a search for a liquid analysis technique the present inventors discovered that information regarding the content of the liquid can be obtained by analyzing the process of drops formation in the liquid.

The method and system of the present embodiments can be used for online monitoring of a liquid, e.g., for quality control in an industrial process, in many industries, include, without limitation, food and beverage, pharmaceutical, chemical, water technology, printing technology and the like.

The method and system of the present embodiments can also be used to analyze biological liquids such as body liquids (e.g., blood, urine, semen). The present embodiments can also be used for comparing between two liquids in any of the aforementioned applications, and also for forensic purposes.

The continuous formation of a liquid drop is governed by the interplay between hydrodynamics and surface-tension forces, including nonlinear forces which are typically associated with the drop breakup.

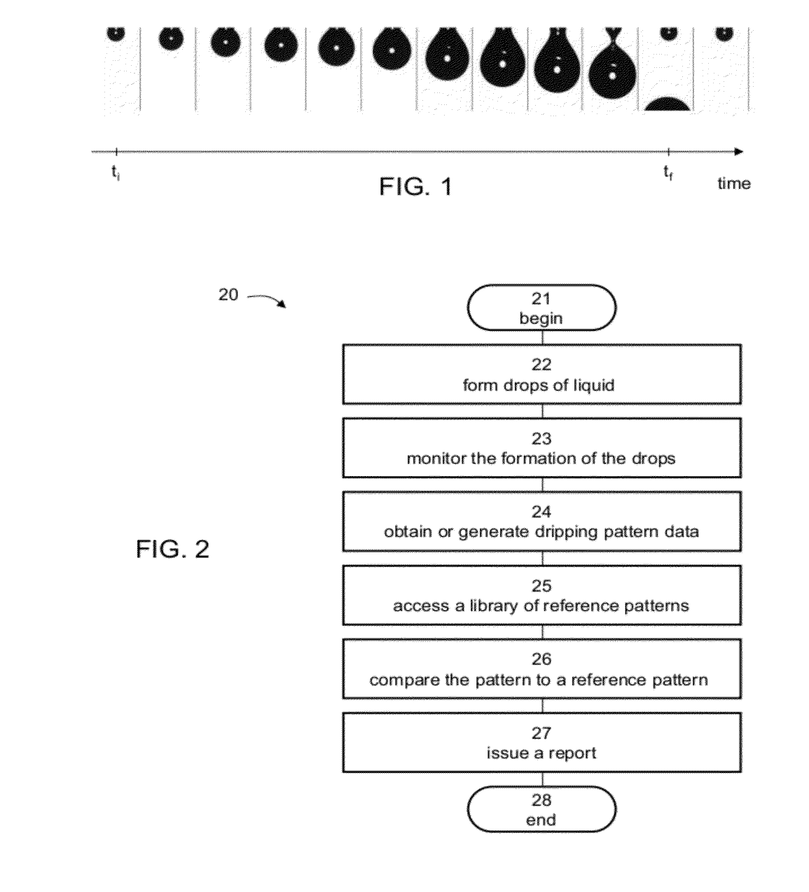

FIG. 1 is a series of images describing the formation of a single liquid drop at a tip of a dripping device under gravitational force. The drop evolution is influenced by two main forces: gravity, which increases as the drop grows larger because of the mass that is added as liquid continues to flow into the drop, and surface-tension, which becomes smaller as the radius of the drop grows. Gravity pulls the drop downward, causing it to elongate, and surface tension pulls the drop inward with a force which tends to minimize surface area and therefore favors spherical surfaces. In the initial stage of each drop build-up, when the radius of the drop is small, surface tension causes the drop to grow while maintaining a spherical shape. When the weight of the pending drop increases, the drop develops into a pear shape with a narrowing neck. As the drop continues to grow, the neck diameter decreases rapidly, leading to the break-up of the liquid and to the detachment of the drop.

The present inventor found that many liquids have the property that for a given liquid and conditions, this cycle is repeated and is substantially identical for all drops emerging from the tip. The present inventor also found that for some liquids, under certain conditions, the dripping process appears to be non-repetitive on a drop-by-drop basis, but can nevertheless be characterized, hence identified, by analyzing a sequence of several drops.

Generally, for given dripping device and flow parameters, the characteristic dripping period and characteristic shape of the liquid drops depend on the type and state of the liquid (e.g., density, viscosity, surface tension). While conceiving the present invention, the present inventors uncovered that since the type and state of the liquid depend on the content of the liquid, the dripping pattern (e.g., the formation pattern of the liquid drops) for given dripping device and flow parameters can be used as an identifying feature or as a criterion for comparing two liquids. The present inventors found that this identifying feature is liquid-specific since there are numerous different relations between the parameters that define the state of the liquid which in turn result in a varying dynamics of drop formation. Thus, it was postulated by the present inventors that for given dripping device and flow parameters, different liquids will have different dripping pattern. The present inventors successfully demonstrated this discovery experimentally.

Referring now again to the drawings, FIG. 2 is a flowchart diagram of a method 20 suitable for analyzing a liquid, according to various exemplary embodiments of the present invention.

The method of the present embodiments can be embodied in many forms. For example, selected operations of the method can be embodied on a tangible medium such as a computer for performing the operations. Selected operations of the method can be embodied on a computer readable medium, comprising computer readable instructions for carrying out the operations. Selected operations of the method can also be embodied in electronic device having digital computer capabilities arranged to run the computer program on the tangible medium or execute the instruction on a computer readable medium.

Computer programs implementing the method or pat thereof can commonly be distributed to users on a distribution medium such as, but not limited to, a floppy disk, CD-ROM, flash memory device and the like. From the distribution medium, the computer programs can be copied to a hard disk or a similar intermediate storage medium. The computer programs can be run by loading the computer instructions either from their distribution medium or their intermediate storage medium into the execution memory of the computer, configuring the computer to act in accordance with the method. All these operations are well-known to those skilled in the art of computer systems.

The method begins at 21 and optionally and preferably continues to 22 at which drops of the liquid are formed, typically using a dripping device such as a dripping faucet having a narrow nozzle or tip. The drops are preferably formed at a rate which ensures periodic dripping from the dripping device. The drops can be formed by any dripping mechanism, including, without limitation, via automatic syringe device, gravitiaonal force or microfluidic dripping technique.

From 22 the method proceeds to 23 at which the formation of the drops are monitored, and 24 at which data pertaining to a dripping pattern is generated responsively to the monitoring. Alternatively, the method can obtain the dripping pattern data from external source, e.g., via a communication channel, in which case 22 and 23 can be skipped.

The term “dripping pattern” as used herein refers generally to the time-dependence of the formation of a drop or a sequence of drops. This time-dependence can be continuous, but is typically in the form of a sequence of features each describing or being correlated to the state of the dripping process at a given time instant.

In some embodiments, the dripping pattern comprises a drop formation pattern.

The term “formation pattern” refers to the time-dependence of the formation of a drop, namely the state of the drop (e.g., size, shape) as a function of the time. This time-dependence can be continuous or it can be in the form of a sequence of features each describing or being correlated to the state of the drop at a given time instant.

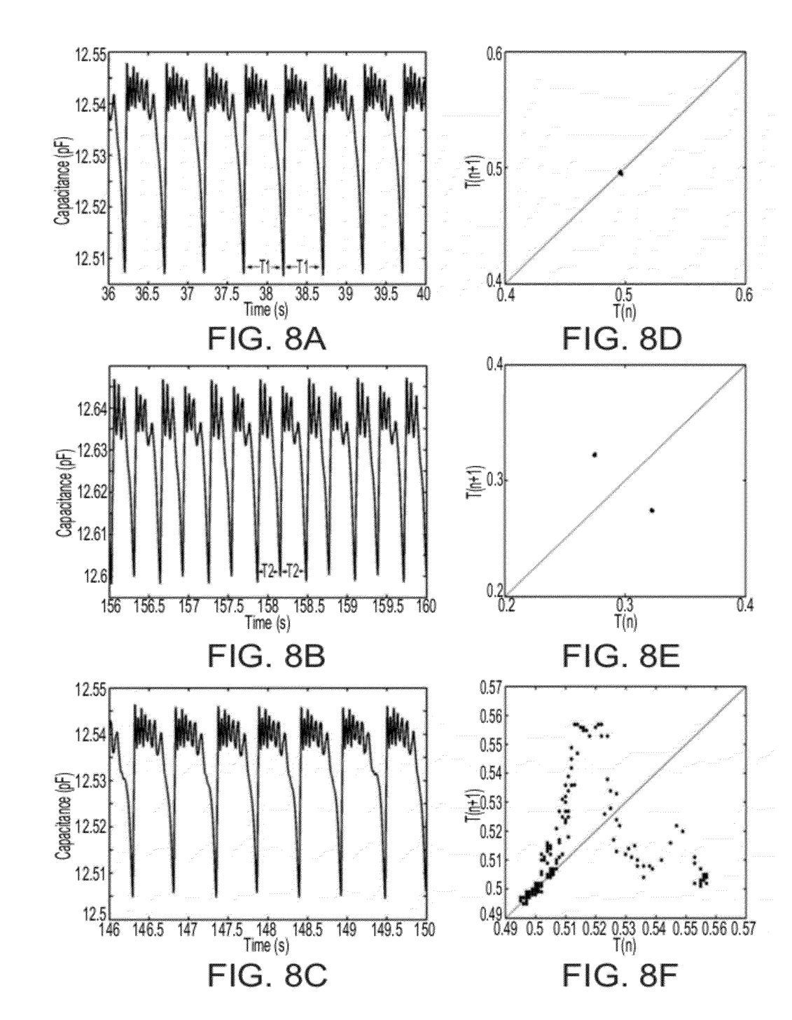

The dripping pattern can also comprise time intervals between drops, dripping rate (also referred to as dripping frequency) and/or other features, e.g., features that can facilitate analysis by means of the chaos theory. For example, the dripping pattern can comprise features facilitating generation of a return map characterizing the dripping dynamic or features facilitating reconstruction of a multidimensional phase space characterizing the dripping dynamic. Representative examples of such dripping patterns are provided in the Examples section that follows (see, e.g., FIGS. 8A-F and 9A-C).

Many types of data that pertain to the dripping pattern are contemplated. In some embodiments of the present invention the data comprise electrical capacitance data describing electrical capacitance measured at a tip of a dripping device while the liquid drops are formed at the tip.

Capacitance is a physical observable, attributed to a conductor or a system of conductors, which observable may be electrostatically defined as the ratio between a change in the electric charge on the conductor and the potential drop resulting from that change. The capacitance, C, of a capacitor depends on its geometry and on dielectric materials, if present, which are adjacent to the conducting components of the capacitor. For example, in a parallel-plate capacitor, sufficiently far from the edges of the plates, the capacity is proportional to the area of the plates, A, and to the dielectric coefficient of the dielectric material, ε, and is inversely proportional to the distance between the plates, d.

This proportion, however, is rather inaccurate near the edges of the plates, where contributions of electric field lines present outside the inter-plate volume become significant. Edge effects have always been treated as limitations which are needed to be overcome, e.g., using large area plates with very small separation therebetween. The present inventors found that these edge effects can be directly exploited for the purpose of characterizing the formation of liquid drops as a function of the time. A more detailed description of this use of electrical capacitance is provided hereinunder.

The present inventors also contemplate other electrical quantities which can be utilized for characterizing the formation of liquid drops as a function of the time. Representative examples include, without limitation, electrical conductance and electrical impedance, each of which can be monitored and recorded at the tip of the dripping device while liquid drops are formed and inputted to the method.

The dripping pattern data can also be digital data which include the characteristic dripping period, namely the time period which characterizes the formation of a single drop. Typically, this time period is measured from the time tᵢ at which a significant amount of liquid first emerges from the tip to the time t_{f} at which the drop detaches from the tip (see FIG. 1). The skilled person would know how to define the time instants tᵢ and t_{f} such that they characterize the formation of a single drop. It is appreciated that although the time period can be used as a liquid identifier, the difference t_{f}−tᵢ may slightly vary along a sequence of drop formation. Thus, in various exemplary embodiments of the invention the characteristic dripping period is taken as an average over several drop formation cycles.

The dripping pattern data can alternatively, and more preferably additionally, comprise a characteristic shape of the liquid drops. The characteristic shape can be defined in any way known in the art. For example, it can be a set of parameters geometrically defining the shape of the drop (e.g., deviation from sphericity, minor and major dimensions of a pear, etc.), it can be digital data describing a locus of points, it can be digital data describing a point cloud and the like.

The characteristic dripping period and/or geometrical characteristics of liquid drops can be extracted from the electrical quantities described above, e.g., by means of a look-up table prepared in advance.

Also contemplated is the use of an optical device for measuring temporal and/or geometrical features characterizing the formation of the drops. For example, an optical device which generates a laser beam can be utilized to determine the characteristic dripping period. The device can also be configured to scan the drops with the laser beam so as to determine the outline of the drops hence provide their characteristic shape. The generated optical data can be inputted directly as optical data. Alternatively, the characteristic dripping period and/or geometrical characteristics of liquid drops can be extracted from the optical data and inputted as digital data.

Additionally contemplated is the use of imaging. For example, the pattern data can be imagery data (e.g., video data or a series of still images) captured while liquid drops are formed. The generated imagery data can be inputted directly as imagery data. Alternatively, the characteristic dripping period and/or geometrical characteristics of liquid drops can be extracted from the imagery data by means of image analysis and inputted as digital data.

In any of the above embodiments, the dripping pattern data can also comprise time intervals between drops, a time return map and/or a phase space diagram or some reconstruction thereof.

A return map is a plot in which a quantity is plotted against a time-delayed version of itself. A return map is also referred to in the literature as a Poincare plot. A return map can therefore be obtained by recording a series of values Sᵢ for the respective quantity (e.g., electrical quantity), one value for each time instant, and generating a plot in the abscissa represents Sᵢ and the ordinate represents Sᵢ₊ₖ, where i and k are integers.

A phase space diagram can be obtained by any technique known in the art. In some embodiments, the time delay technique is employed for reconstructing the phase space of the process. The basic idea of phase space reconstruction by time delay embedding is that an orbit (or, equivalently, a sequence of points in some multivariable space observed at time differences of sampling times) which is projected onto a single axis, may, by virtue of the projection, overlap with itself. If the orbit can be unfolded by providing independent coordinates for a multidimensional space made out of the observations, then the overlaps coming from the projection can be undone and orbits can be recovered which are not ambiguous. The time delay technique allows reconstructing a phase space in which the invariant properties are preserved and is therefore equivalent to the original phase space.

The phase-space dynamics can be reconstructed as follows. Consider a scalar time series of measurements (e.g., electrical measurements) v(n), where n is the index for the time series measurement (n=1, 2, 3, . . . N), and N is the number of indices. A d-dimensional set of vectors is obtained from a scalar time sequence of integer delays of the scalar observations: y(n)=[v(n), v(n+T), v(n+2T), . . . , v(n+(d-1)T)], where: v(n) is the original time series measurement at time n; v(n+T) is a measurement from the same time series offset by a time delay interval T (T can be positive or negative); v(n+2T) is a measurement from the same time series offset by time delay interval 2T; v(n+(d-1)T) is a measurement from the same time series offset by time delay interval (d-1)T, and d is the embedding dimension. In performing the phase-space embedding, the initial task is to determine appropriate values for T and d. The geometric basis for the phase-space reconstruction is that, starting with a scalar time series of a single variable (i.e., in one dimension), one is able to reconstruct in d dimensions, the structure of a dynamical system in a so-called multivariate state-space in which the structure can be observed and quantified.

In some embodiments, the dripping pattern data comprises at least one of the embedding dimension d and the time delay interval T used in the phase-space reconstruction.

Broadly speaking, for a given liquid and condition, the dripping dynamic can be a single-period dynamic, a multi-period dynamic or a non-periodic dynamic.

A dripping dynamic is said to be “single-periodic” if the formation process of any two consecutive drops is generally the same both in terms of the time period which characterizes the formation of a single drop and in terms of the evolution of the drop during this time period.

A dripping dynamic is said to be “multi-periodic” if there exists a positive integer constant h such that the formation process of the ith and jth drops is the generally the same for any i and j satisfying j−i=h, where i, j and h are positive integers which are not larger than the total number of drops N.

A dripping dynamic is said to be “non-periodic” if it is neither single-periodic nor multiperiodic.

In some embodiments of the present invention the data can include a flow rate at which there is a transition from one type of dripping dynamic (e.g., one level of periodicity) to another. Such data can be obtained by varying the flow rate and analyzing the dripping pattern, particularly whether the dripping is single-periodic, multi-periodic or non-periodic, for each flow rate.

For example, the data can include a flow rate at which there is a transition from a single-period dripping to a multi-period dripping, and/or a flow rate at which there is a transition from a single-period dripping to a multi-period dripping, and/or a flow rate at which there is a transition from a multi-period dripping to a non-periodic dripping, etc.

Once the dripping pattern data is obtained or generated, the method compares 26 the dripping pattern to a reference dripping pattern.

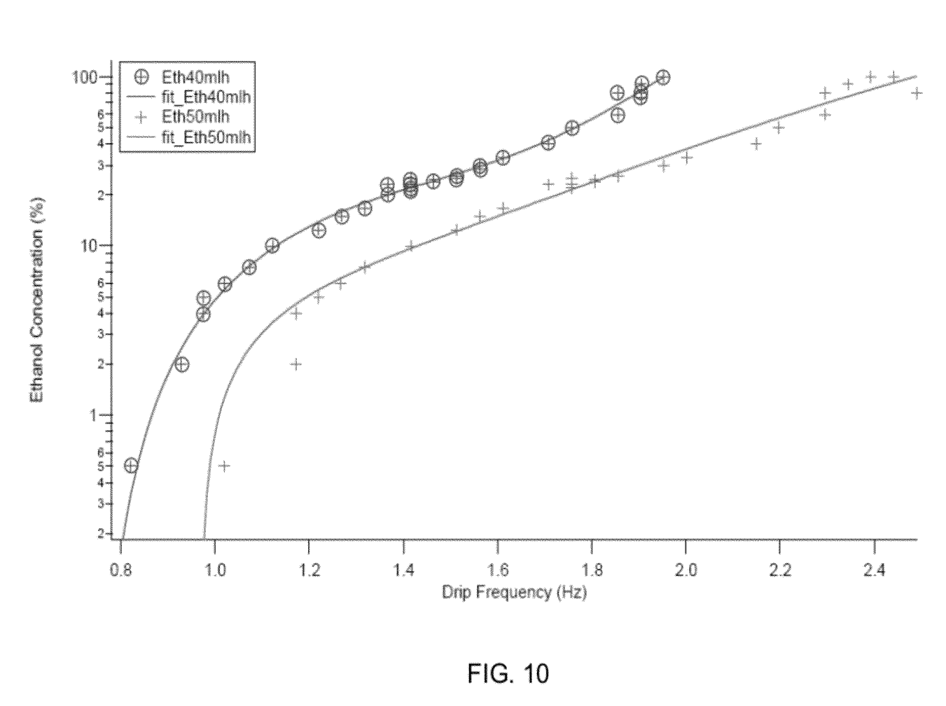

The reference dripping pattern can be a dripping pattern that characterizes the formation of drops of a liquid that its type (e.g., concentrations of the liquid components and/or other objects present therein) is known, and that was recorded at an earlier time. Alternatively, reference dripping pattern can be a dripping pattern that characterizes the formation of drops of another liquid even when its specific type is not known. This embodiment is particularly useful when it is desired to compare two liquids but it is not necessary to determine their type. Also contemplated are reference dripping patterns which are in the form of a calibration curve or lookup table. In these embodiments, the investigated pattern is used for locating the liquid type or property (e.g., concentration) that corresponds to the investigated pattern on the calibration curve or lookup table. Representative examples of these embodiments are provided in the Example section that follows (see, e.g., FIG. 10).

The reference and investigated patterns preferably correspond to dripping of liquid at the same conditions, e.g., the same dripping device, the same flow parameters the same temperature, the same environment and the like.

Optionally and preferably, the method access 25 a database of reference dripping patterns and searches the database for a reference dripping pattern that best matches the pattern obtained at 24. The method can perform the comparison using any technique known in the art. When the data are digital, the method can do the comparison arithmetically. When the data are in the form of curves (e.g., a value of an electrical quantity as a function of the time), the method can perform curve fitting. When the data are images, the method can employ image processing technique for comparing the images. All these operations are well known to those skilled in the art of data analysis.

The method optionally continuous to 27 at which a report regarding the comparison is issued. The report can include the type of liquid (e.g., concentrations of the liquid components or other objects present therein) that correspond to the matched reference pattern. In some embodiments of the present invention the report includes the degree of similarity between the pattern and the reference pattern.

The method ends at 28.

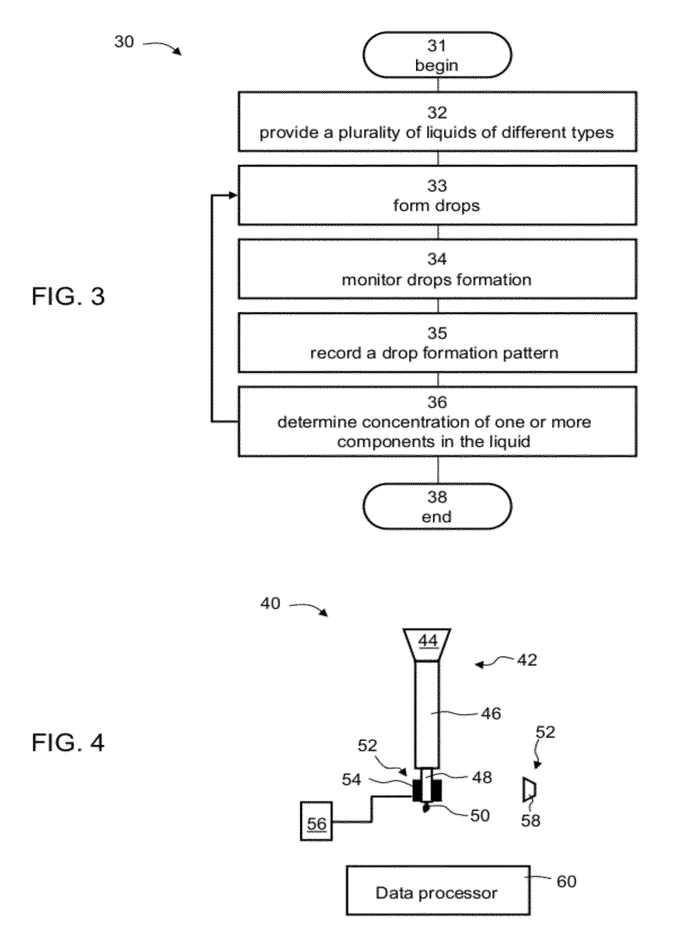

FIG. 3 is a flowchart diagram describing a method 30 suitable for constructing a database, according to various exemplary embodiments of the present invention. Once constructed, the database can be used by method 20 as a reference dripping pattern database, as further detailed hereinabove.

The method begins at 31 and continues to 32 at which a plurality liquids of different types is provided. The following description is for operations which are preferably performed for each liquid provided at 32.

At 33 the method forms drops of the liquid, typically using a dripping device such as a dripping faucet having a narrow nozzle or tip. From 33 the method proceeds to 34 at which the formation of the drops is monitored to assess a dripping pattern characterizing the formation as a function of the time. The monitoring can be by a monitoring device configured for measuring any of the aforementioned quantities which characterize the formation. Thus, in some embodiments of the present invention, the monitoring includes measuring electrical capacitance while the liquid drops are formed, in some embodiments the monitoring includes measuring electrical conductance while the liquid drops are formed, in some embodiments the monitoring includes measuring electrical impedance while the liquid drops are formed, in some embodiments the monitoring includes using an optical device for measuring temporal and/or geometrical features characterizing the formation of the drops, and in some embodiments the monitoring includes imaging liquid drops while liquid drops are formed.

The method continues to 35 at which a dripping pattern characterizing the formation of the drops as a function of the time is recorded. The recorded pattern can be in a digital form specifying the characteristic dripping period and/or characteristic shape of liquid drops. Alternatively, the recorded pattern can be the raw data (e.g., capacitance, conductance, impedance, optical measurements, images) as acquired during monitoring. The method preferably records also the type of liquid such as to associate the type of the liquid with the recorded pattern. Thus, a database entry is constructed, which entry includes a liquid type and a corresponding dripping pattern.

Optionally and preferably, the method also determine 36 the concentration of one or more components in the liquid, e.g., liquid components if the liquid is a mixture, non-liquid objects if the liquid is a composition that includes such objects. In this embodiment, the method also records the concentration as corresponding to the respective dripping pattern.

The concentration can be determined by any technique known in the art, include, without limitation, chemical analysis, spectral analysis, biological analysis and any combination thereof.

Optionally and preferably, the method also records the conditions in which the dripping was executed. For example, the method can record the type and dimension of the dripping device, the flow parameters the temperature, and the like.

The method preferably loops back to 33 and executes at least some of the operations 33-36 for another liquid type.

The method ends at 38.

FIG. 4 is a schematic illustration of a system 40 for analyzing liquid, according to various exemplary embodiments of the present invention. System 40 can be used for executing at least some of the operations of methods 20 and 30.

System 40 comprises a dripping device 42 for forming drops 50 of the liquid. Dripping device can comprise an inlet port 44 a flow channel 46 and a nozzle or tip 48 at which drops 50 are formed.

System 40 further comprises a monitoring device 52 which monitors the formation of drops and generates data pertaining to dripping pattern characterizing the formation of liquid drops as a function of the time.

Many types of monitoring devices are contemplated. In some embodiments of the present invention the monitoring device 52 comprises electrodes 54 which are arranged as a capacitor on the walls of tip 48. Electrodes 54 are connected to a measuring device 56. The capacitor typically comprises two surface electrodes 54, which may be either formed on, or integrated with tip 48. Measuring device 56 serves for charging the capacitor and measuring the capacitance thereof.

Following is a description of the physical concepts of electric potential and electric field, which, for simplicity, is given for the case of a parallel-plate capacitor. It is to be understood that other types of capacitors are not excluded from the scope of the present invention.

The electric field, generated by the electrostatic charge of the capacitor equals the gradient of the electric potential, which satisfies the Poisson equation. For any given boundary conditions, dictated by the geometry of the electrical system, the Poisson equation has a unique solution. For a parallel-plate capacitor, when the fluid is in a stationary state, the boundary conditions of the Poisson equation are such that, far from the edges of the capacitor, the electric potential is substantially uniform in the inter-electrode. Geometrically, the solution for the Poisson equation in the inter-electrode is represented as a plurality of closed equipotential surfaces winding the electrodes of the capacitor. Far from the edges the equipotential surfaces are substantially flat and parallel to the electrodes, while near the edges the equipotential surfaces acquire a curvature.

Being the gradient of the electric potential, the electric field is perpendicular to the equipotential surfaces, hence directed from one plate (the positively charged plate) to the other (the negatively charged plate). Thus, the electric field lines are substantially straight in the center of inter-electrode volume and curved near the edges.

When fluid drop 50 is formed at tip 48, the (curved) electric field near the edge of the electrodes induces a non-uniform polarization (e.g., charge distribution) on the surface of drop 50. The polarization now serves as a secondary source, hence alters the boundary conditions of the Poisson equation and the corresponding electric potential. As stated, the electrostatic definition of a capacitance is the ratio between a change in the electric charge on the conductor and the potential drop resulting from that change. Thus, knowing the charge on the capacitor, the measurement of its capacitance is practically an indirect measurement of the electric potential. As the electric potential depends on the shape and dielectric constant of drop 50, a change in a capacitance of the capacitor is correlated to the state of the drop.

Broadly speaking, the formation of drop 50 typically increases the dielectric constant of the medium adjacent to the edge of the capacitor such that when the drop starts to form, the capacitance increases, and when the drop finally detaches from tip 48 there is a sudden decrement in the capacitance. In some rare cases, when the dielectric constant of the dripping liquid is smaller than the ambient dielectric constant, the behavior of the capacitance is reversed, i.e., in such cases, the formation of the drop decreases the dielectric constant of the medium adjacent to the edge of the capacitor such that that when the drop starts to form, the capacitance decreases, and when the drop detaches from the tip there is a sudden increase in the capacitance.

In any event, the formation of the drops can be monitored by measuring the capacitance as a function of the time.

In some embodiments of the present invention the electrodes 54 are arranged to sense electrical conductance at tip 48 and device 56 is configured for measuring electrical conductance. Similarly to the capacitance, a change in the electrical conductance at the tip is correlated to the state of the drop. Thus, the electrical conductance measured by device 56 can be used for monitoring the formation of the drop.

In some embodiments of the present invention the electrodes 54 are arranged to sense electrical impedance at tip 48 and device 56 is configured for measuring electrical impedance. Similarly to the capacitance and conductance, a change in the electrical impedance at the tip is correlated to the state of the drop. Thus, the electrical impedance measured by device 56 can be used for monitoring the formation of the drop.

In some embodiments of the present invention monitoring device 52 comprises an optical device 58. Device 58 can be a laser device which generates a laser beam and configured for determining the characteristic dripping period. Device 58 can also be configured to scan the drops with a laser beam so as to determine the outline of the drops hence provide their characteristic shape. Device 58 can also be an imaging device which captures the dripping in the form of a video image or a series of still images.

Device 52 can provide the dripping pattern data as raw data, namely the measured quantities (e.g., a electrical quantity as a function of the time, optical data, imagery data). Device 52 can also have computation functionality (e.g., data processing means) which extracts the characteristic dripping period, periodicity level and/or geometrical characteristics of liquid drops from the measured quantities.

System 40 further comprises a data processor 60 which receives the dripping pattern from monitoring device 52 and compares it to a reference dripping pattern, as further detailed hereinabove. For clarity of presentation, communication channels between data processor 60 and monitoring device 52 are not shown in FIG. 4. In various exemplary embodiments of the invention data processor 60 is configured for accessing a database of reference dripping patterns, and searching the database for a matching reference dripping pattern, as further detailed hereinabove.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

### Example 1

### Exemplified System

An exemplified system in accordance with some embodiments of the present invention was prepared and successfully employed for correlating between capacitance and formation of liquid drops.

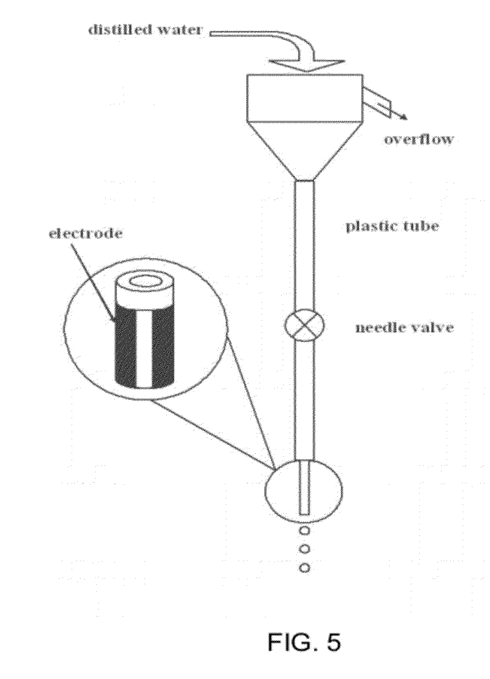

The exemplified system is schematically illustrated in FIG. 5.

The system includes a nozzle that incorporates two facing electrodes, whose mutual capacitance during the dripping process reflects the geometry of the water neck emanating from the nozzle. The nozzle was constructed using either glass- or quartz-made pipettes, on which metal electrodes were placed to form the capacitor. The glass nozzles were cut from commercial Pasteur pipettes which had an inner diameter of 6.9 mm and outer diameter of 8.96 mm. Two conductive adhesive-strips, which were placed along the pipettes facing each other, served as the capacitor. For the smaller quartz nozzle, which had an inner diameter of 0.5 mm and an outer diameter of 1 mm, the two facing electrodes were made of evaporated Ti—Au strips. Capacitance between the electrodes was monitored by measuring the voltage across the balancing arm of a ratio-arm transformer capacitance bridge using a standard AC lock-in technique using an excitation voltage of 5V at 10 KHz.

The system was applied for analysis of liquid and several experiments. All experiments were performed at a temperature of 22±0.5° C. The liquid used was double distilled water with a resistance of ≧17 MΩ. To drive the liquid through the large pipette, a gravitational based system was employed. The system maintained a fixed water level. For the small quartz pipette a syringe pump drove the flow at a constant rate with ±2% accuracy.

All experiments were conducted in an enclosed chamber that provided both electrical and noise isolation. The entire setup was mounted on an optical table to prevent vibrations. For some of the experiments the drop formation process was also imaged using a digital camera attached to a microscope.

As a first step in the study, the capacitance signal was correlated with the evolution of a single drop. Time-laps video images of the forming drops taken at a rate of 44 frames per second were correlated with the capacitance measurement at rate of 5000 samples per second.

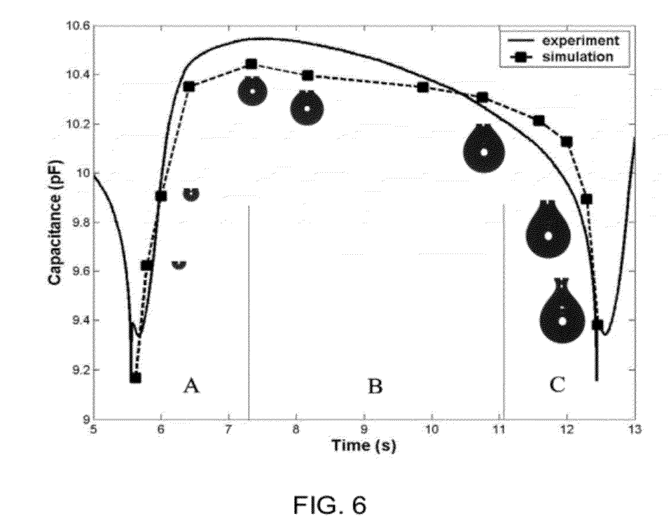

The results are shown in FIG. 6. The solid line in FIG. 6 shows the capacitance trace measured during the buildup of one drop in the small quartz nozzle. As shown the evolution and breakup of a drop has a clear signature in the capacitance trace obtained from the two electrodes.

FIG. 6 superimposes, over a single drop formation cycle, microscope images of the drop at the appropriate time points to exemplify the geometry of the drop at the various stages of drop formation. In a first stage, the drop grows rapidly while it is attached to the capillary, maintaining a spherical shape. During this stage the capacitance increases (region A in FIG. 6). The relative time scale for this process is very short and hence the sharp increase in capacitance. When equilibrium between gravity and surface tension is lost to the weight of the pending drop, a second stage follows in which the drop develops into a pear shape with a narrow neck. This necking results in a lower volume of liquid near the nozzle and therefore a reduction in capacitance. At first, the equilibrium loss process and therefore neck formation are slow and only a mild decrease in capacitance appears (region B in FIG. 6). As the drop approaches its critical volume the neck diameter decreases rapidly, resulting in a sharp decrease in capacitance until finally the drop breaks up. At this point the capacitance signal reaches its minimum value (region C in FIG. 6). Also plotted, as a dashed line in FIG. 6, is the capacitance calculated by solving three-dimensional Poisson equation for a geometry obtained from the video images considering axially symmetric drops.

A clear correspondence between the measured capacitance and the calculated capacitance is evident from FIG. 6. The present inventors concluded that the capacitance signal successfully provides a continuous electronic measurement of the drop formation pattern.

### Example 2

### Liquid Analysis

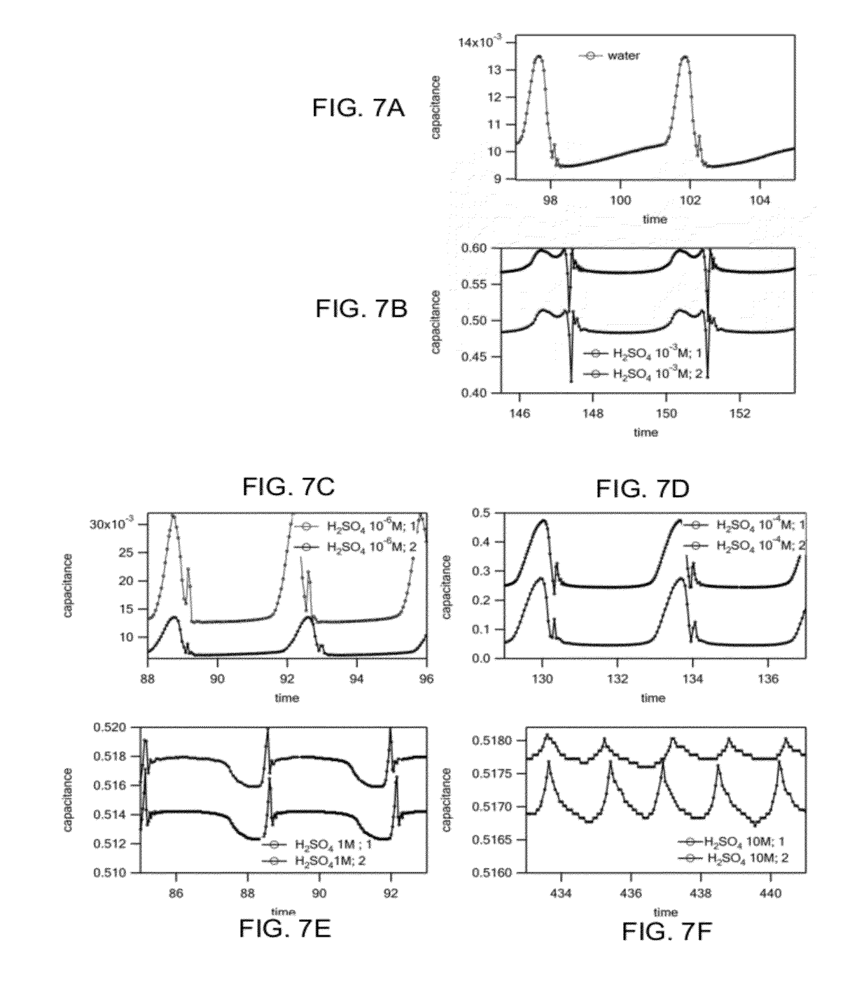

An exemplified system similar to the system described in of Example 1 was used for the analysis of liquids of different types. The formation of drops of different concentrations of sulphuric acid was monitored. The resulting drop formation patterns are displayed in FIGS. 7A-F in the form of capacitance time traces.

Shown in FIGS. 7A-F are data corresponding to 5 different type of liquids. FIG. 7A shows the capacitance as a function of the time for water; FIG. 7B shows the capacitance as a function of the time for two solutions of sulphuric acid and water in concentration of 10⁻³ M; FIG. 7C shows the capacitance as a function of the time for two solutions of sulphuric acid and water in concentration of 10⁻⁶ M; FIG. 7D shows the capacitance as a function of the time for two solutions of sulphuric acid and water in concentration of 10⁻⁴ M; FIG. 7E shows the capacitance as a function of the time for two solutions of sulphuric acid and water in concentration of 1 M; FIG. 7F shows the capacitance as a function of the time for two solutions of sulphuric acid and water in concentration of 10 M.

FIGS. 7B-E demonstrate that liquids of the same type have the same drop formation patterns and can therefore by compared and indentified by their drop formation patterns. FIGS. 7A-F further demonstrate that liquids of different concentration have different drop formation and dripping patterns and can therefore be identified based on the drop formation and dripping patterns.

### Example 3

### Study of Dripping Dynamic

The exemplified system of Example 1 was used to study the connection between the formation of a single drop and the dynamics of drop formation.

FIGS. 8A-C shows measurements obtained from the glass tube, for average drip rates of 2 drops/sec, 3.25 drops/sec and 1.8 drops/sec that lead to periodic (FIG. 8A), quasi periodic (FIG. 3B) and chaotic (FIG. 3C) behaviors. These measurements were used to follow both drop formation and the drip rate.

The dripping measurements demonstrate an oscillatory process superimposed on the second stage of the drop formation process (region B in FIG. 6). The source of oscillations is the recoil of the water bridge, which remains attached to the water in the tube, following drop breakup. The pending drop oscillates at the same time it grows and the synchronization between these two motions may determine the dynamics of the system. When the drops attain their critical volume they break up and the residual bridge oscillates. If these oscillations are not damped out by the time the next drop attains its critical volume they can modify the onset of instability if they occur in the vicinity of instability. Breakup time depends on the oscillations; their synchronization with the instability point and their direction relative to the dripping direction.

Following is a description of a method suitable for obtaining the time intervals between drops. After identifying a single dripping event by capacitance measurement the cross-correlation of this event with the time trace obtained during the entire flow was measured. The dripping events are then identified with the instances of time for which the cross-correlation function has a maximum and the time intervals are the time differences between adjacent maxima.

The time intervals are plotted using return maps in FIGS. 8D-F. Return maps offer a convenient tool to illustrate the dynamics of a series of events. Periodic behavior, for instance, is evident in a return map as a single point on the diagonal of the graph as shown in FIG. 8D. Looking at the dripping time-trace (FIG. 8A) corresponding to this return map, one sees that all drops exhibit nearly identical capacitance structure, with the same number of oscillations and the same magnitude of the dip in the capacitance.

This implies that oscillations and drop formation processes do not influence each other, therefore all drops are uniform.

For a different flow rate of 3.25 drops/second (FIG. 8B), the time-return map (FIG. 8E) changes. Instead of the single point corresponding to periodic dripping two points mirrored about the diagonal were observed. This indicates that the dripping process involves two alternating periods, marked in FIG. 8B by T₁ and T₂.

Concomitant with the appearance of two alternating periods in the dripping process, two alternating patterns of the evolution of individual drops were observed. The first structure (T₁ in FIG. 8B) incorporates three oscillations, while the second (structure T₂ in FIG. 8B) has four smaller-amplitude oscillations. The T₂ structure has also a larger dip of the capacitance than that of T₁.

At an intermediate flow rate of 1.8 drops/sec (FIG. 8C) synchronization is lacking and an irregular dripping pattern was observed. The corresponding return map (FIG. 8E) indicates that the dripping was chaotic and is characterized by a single strange attractor.

A known technique to analyze the multidimensional phase space of the dynamics is the method of time delays [Kiyono et al., Phys. Lett. A 320, 47 (2003)]. In the method of time delays, for a single observable xⱼ, d-dimensional pseudo vectors yⱼ are built with elements being the sampled observable separated by a constant delay time, such that yⱼ=[xⱼ; xⱼ₊ₕ; . . . ; xⱼ₊ₕ(d-1)]; where h is the delay index, and d the embedding dimension, both of which are to be determined. Reconstructing the phase space of a dynamical system requires a continuous smooth parameter and thus no such experimental reconstruction exists for the dripping faucet.

The capacitance measurements of the present embodiments were used as a continuous parameter in order to reconstruct the phase space using the time delay method. First the optimal time delays were calculated using the average mutual information function. These were found to be T=16 msec for the period one reconstruction, T=21 msec for period two reconstruction and T=17 msec for the chaotic reconstruction. Next, the embedding dimension was calculated. This was found to be 3. For this purpose the false nearest neighbors (FNN) method was used. This method finds the nearest neighbor of every point in a given dimension and checks to see if these points are still close neighbors in one higher dimension. Thereafter, the time delay method was used for building a three dimensional graph in which the XYZ axes correspond to C(t), C(t+T), C(t+2T), respectively.

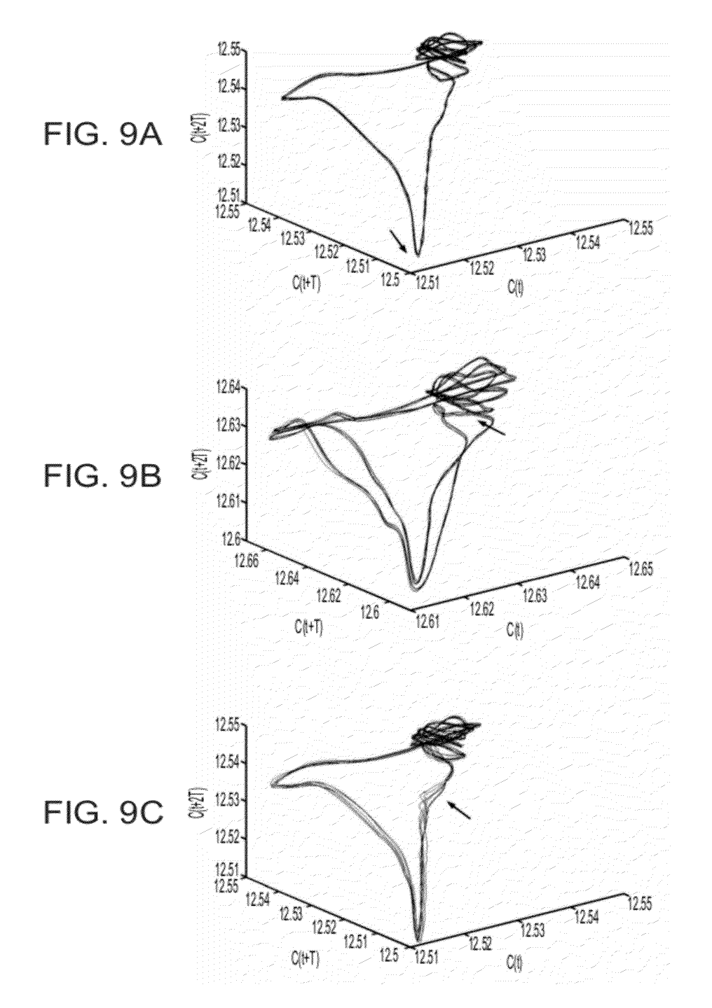

FIGS. 9A-C show the obtained three dimensional graphs. FIG. 9A shows the dynamical behavior obtained for period one dynamics. The trajectory is repetitive; a trademark of periodic behavior and shows the oscillatory process and the long trajectory toward the breakup point (see arrow) and then drop buildup. FIG. 9B contains two distinct trajectories which join near the breakup point but separated otherwise. Every second trajectory has an extra oscillation (see arrow) which occurs in an initial stage of instability, and therefore influences the breakup time. FIG. 9C shows phase space for chaotic dynamics, the last oscillation (see arrow), in every path, occurs in a developed stage of instability, its influence is less significant on the time to breakup.

### Example 4

### Analysis of Ethanol in Water

An exemplified system similar to the system described in of Example 1 was used for the analysis solutions of ethanol in water at concentrations ranging from 0.5% to 100%. For each concentration the dripping frequency was measured and recorded. The experiment was repeated for two different flow rates were tested: 40 ml/hr and 50 ml/hr.

FIG. 10 shows the concentration in percentage (logarithmic scale) as a function of the dripping frequency (Hz), for a flow rate of 40 ml/hr (upper curve and symbols) and 50 ml/hr (lower curve and symbols). The symbols indicate the dripping rate as measured for the respective concentration. The solid lines are numerical fits of the data.

FIG. 10 demonstrates that liquids of different concentrations have different dripping patterns (in the present example, different dripping rate) and can therefore be identified based on the dripping patterns. Specifically FIG. 10 shows that the concentration is a monotonically increasing function of the dripping frequency. This observation can be exploited according to some embodiments of the present invention for liquid analysis. In some embodiments, solutions of two or more unknown different concentrations are caused to drip in the same flow rate, and the dripping frequency is measured. The solutions can then be classified according to the dripping frequency wherein larger dripping frequency indicates larger concentration. In some embodiments of the present invention a calibration curve, such as the numerical fit curves shown in FIG. 10, or a lookup table is used for determining the concentration of a liquid. Specifically, for each liquid, the measured dripping frequency is used for locating the corresponding concentration on the calibration curve or lookup table.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method of analyzing liquid, comprising:
obtaining data pertaining to a dripping pattern characterizing formation of liquid drops as a function of the time;
comparing said dripping pattern to a reference dripping pattern; and
issuing a report regarding said comparison thereby analyzing the liquid.

2. The method according to claim 1, further comprising accessing a database of reference dripping patterns, and searching said database for said reference dripping pattern.

3. The method according to claim 1, further comprising:
forming drops of the liquid;
monitoring the formation of said drops; and
generating said data pertaining to said dripping pattern responsively to said monitoring.

4. The method according to claim 3, further comprising varying a flow rate of the liquid, wherein said monitoring and said generation of said data is repeated for at least two different flow rates.

5. The method according to claim 1, wherein said data comprise electrical capacitance data describing electrical capacitance measured at a tip of a dripping device while said liquid drops are formed at said tip.

6. The method according to claim 1, wherein said data comprise electrical conductance data describing electrical conductance measured at a tip of a dripping device while said liquid drops are formed at said tip.

7. The method according to claim 1, wherein said data comprise electrical impedance data describing electrical impedance measured at a tip of a dripping device while said liquid drops are formed at said tip.

8. The method according to claim 1, wherein said data comprise optical data characterizing said formation of liquid drops.

9. The method according to claim 1, wherein said data comprise imagery data captured while said liquid drops are formed.

10. The method according to claim 1, wherein said data comprise at least one of: characteristic dripping period, characteristic shape of said liquid drops, time intervals between drops, characteristic dripping rate, characteristic necking speed, characteristic periodicity level, and a flow rate corresponding to a transition from one dripping dynamic to another dripping dynamic.

11. The method according to claim 1, wherein said reference dripping pattern is in a form of a calibration curve or lookup table, wherein said comparing said dripping pattern to said reference dripping pattern comprises locating a liquid type or property corresponding to said dripping pattern on said calibration curve or lookup table.

12. The method according to claim 1, wherein said data correspond to at least one of: a time return map characterizing said formation of liquid drops, and a phase space reconstruction diagram characterizing said formation of liquid drops.

13. The method according to claim 1, wherein said data comprises at least one of an embedding dimension and a time delay interval characterizing a phase-space reconstruction of said formation of liquid drops.

14. Computer-readable medium having stored thereon a computer program comprising code means for instructing a data processer to carry out the method according to claim 1.

15. A system for analyzing liquid, comprising:
a dripping device for forming drops of the liquid;
a monitoring device for monitoring the formation of said drops and generating data pertaining to dripping pattern characterizing formation of liquid drops as a function of the time; and
a data processor configured for comparing said dripping pattern to a reference dripping pattern.

16. The system of claim 15, wherein said data processor is configured for accessing a database of reference dripping patterns, and searching said database for said reference dripping pattern.

17. The system according to claim 15, wherein said monitoring device comprises an electrical capacitance measuring device configured for measuring electrical capacitance measured at a tip of said dripping device while said liquid drops are formed at said tip.

18. The system according to claim 15, wherein said monitoring device comprises an electrical conductance measuring device configured for measuring electrical conductance at a tip of said dripping device while said liquid drops are formed at said tip.

19. The system according to claim 15, wherein said monitoring device an electrical impedance measuring device configured for measuring electrical impedance measured at a tip of said dripping device while said liquid drops are formed at said tip.

20. The system according to claim 15, wherein said monitoring device comprises an optical device configured for measuring temporal and/or geometrical features characterizing said formation of said liquid drops.

21. The system according to claim 15, wherein said monitoring device comprises an imaging device configured for imaging said liquid drops while said drops are formed at a tip of said dripping device.

22. The system according to claim 15, wherein said data comprise at least one of: characteristic dripping period, characteristic shape of said liquid drops, time intervals between drops, characteristic dripping rate, characteristic periodicity level, and a flow rate corresponding to a transition from one dripping dynamic to another dripping dynamic.

23. The system according to claim 15, wherein said reference dripping pattern is in a form of a calibration curve or lookup table, wherein said data processor is operable to locate a liquid type or property corresponding to said dripping pattern on said calibration curve or lookup table.

24. The system according to claim 15, wherein said data correspond to at least one of: a time return map characterizing said formation of liquid drops, and a phase space reconstruction diagram characterizing said formation of liquid drops.

25. The system according to claim 15, wherein said data comprises at least one of an embedding dimension and a time delay interval characterizing a phase-space reconstruction of said formation of liquid drops.

26. A method of constructing a database, comprising:
providing a plurality liquids of different types; and
for each liquid type, forming drops of said liquid, monitoring the formation of said drops to assess a dripping pattern characterizing said formation as a function of the time, and recording said dripping pattern as an identifying feature of said liquid type;
thereby constructing a database of dripping patterns.

27. The method of claim 26, further comprising, for each liquid type, determining a concentration of at least one component in said liquid and recording said concentration as corresponding to a respective dripping pattern.

28. The method of claim 27, wherein said determining said concentration is by at least one analysis technique selected from the group consisting of chemical analysis, spectral analysis, biological analysis and any combination thereof.

29. The method according to claim 27, wherein said monitoring comprises measuring electrical capacitance at a tip of a dripping device while said liquid drops are formed at said tip.

30. The method according to claim 27, wherein said monitoring comprises measuring electrical conductance at a tip of a dripping device while said liquid drops are formed at said tip.

31. The method according to claim 27, wherein said monitoring comprises measuring electrical impedance measured at a tip of a dripping device while said liquid drops are formed at said tip.

32. The method according to claim 27, wherein said monitoring comprises using an optical device for measuring temporal and/or geometrical features characterizing said formation of said liquid drops.

33. The method according to claim 27, wherein said monitoring comprises imaging said liquid drops while said liquid drops are formed.

34. The method according to claim 27, wherein said recording said dripping pattern comprising recording data which comprise at least one of: characteristic dripping period, characteristic shape of said liquid drops, time intervals between drops, characteristic periodicity level, and a flow rate corresponding to a transition from one dripping dynamic to another dripping dynamic.

35. The method according to claim 27, wherein said recording said dripping pattern comprises recording data which correspond to at least one of: a time return map characterizing said formation of liquid drops, and a phase space reconstruction diagram characterizing said formation of liquid drops.

36. The method according to claim 27, wherein said data comprises at least one of an embedding dimension and a time delay interval characterizing a phase-space reconstruction of said formation of liquid drops.
